(19) United States
(12) Patent Application Publication
(10) Pub. No.: US 2018/0209472 A1
(43) Pub. Date: Jul. 26, 2018

(54) BEARING COVER

(71) Applicant: Miba Sinter Austria GmbH, Laakirchen (AT)

(72) Inventors: Karl DICKINGER, Vorchdorf (AT); Manuel STEINMAURER, Steinerkirchen (AT); Martin KARLSBERGER, Eberstalzell (AT); Markus SCHAUER, Gunskirchen (AT); Wolfgang SCHIMPL, Scharnstein (AT)

(73) Assignee: Miba Sinter Austria GmbH, Laakirchen (AT)

(21) Appl. No.: 15/867,841

(22) Filed: Jan. 11, 2018

(30) Foreign Application Priority Data
Jan. 24, 2017 (AT) A 50043/2017

(51) Int. Cl. F16C 9/02

(52) U.S. Cl. CPC F16C 9/02

(57) ABSTRACT

The invention relates to a bearing cover (3) for a split bearing arrangement (1), which in addition to the bearing cover (3) comprises a bearing block (2), wherein the bearing cover (3) comprises clamping surfaces (7), which in the assembled state of the bearing arrangement (1) bear on counter clamping surfaces (8) of the bearing block (2), and the clamping surfaces (7) have a sinter-roughened surface at least in some areas.

The invention relates to a bearing cover for a split bearing arrangement which in addition to the bearing cover comprises a bearing block, wherein the bearing cover comprises clamping surfaces, which in the assembled state of the bearing arrangement bear on counter clamping surfaces of the bearing block.

The invention also relates to a split bearing arrangement comprising a bearing cover and bearing block bearing on the latter.

Furthermore, the invention relates to a method for the production of a bearing cover by means of powder metallurgy for a split bearing arrangement, which in addition to the bearing cover comprises a bearing block, wherein the bearing cover comprises clamping surfaces, which in the assembled state of the bearing arrangement bear on counter clamping surfaces of the bearing block, comprising the steps of pressing metallic powder into a green compact in the form of the bearing cover and sintering the green compact at sintering temperature to form a sintered bearing cover.

In addition, the invention relates to the use of a bearing cover produced by means of powder metallurgy in a split bearing arrangement, which in addition to the bearing cover comprises a bearing block, wherein the bearing cover comprises clamping surfaces, which in the assembled state of the bearing arrangement bear on counter clamping surfaces of the bearing block.

The production of bearing covers for split bearing arrangements, as used for example in connecting rods, by using a powder metallurgical method has already been described in the prior art. For example DE 39 04 020 A1 describes a method for the production of components with a split bearing eye, in particular connecting rods for internal combustion engines, which are formed by sintering, wherein the components forming the bearing eye are pre-pressed and sintered and are subsequently placed into a calibrating mold forming the bearing eye and subsequently pressed (calibrated).

Bearing covers are components which normally need to have a high degree of dimensional accuracy, i.e. low tolerances. For this reason, bearing covers produced by powder metallurgy are usually calibrated. In powder metallurgy calibration is a method step in which the finally sintered component is placed back into a die and subsequently pressed. Here the compactness of the component increases on the surface and imprecisions in the surface are levelled out, thereby reducing the surface roughness. Calibration also has the advantage that there is less need or no need for the further mechanical post-processing of the components.

The underlying objective of the invention is to provide a split bearing arrangement with improved tensioning of the bearing cover to the bearing block.

The term “tensioning” can be interpreted broadly and also includes re-tensioning, in case the bearing cover needs to be disassembled for maintenance purposes.

The objective of the invention is achieved with the aforementioned bearing cover in that at least the clamping surfaces have a sinter-roughened surface at least in some areas.

The objective is also achieved by the split bearing arrangement which comprises a bearing cover according to the invention.

Furthermore, the objective of the invention is achieved by the aforementioned method, according to which at least the clamping surfaces remain untreated after sintering at least in some areas.

In addition, the objective of the invention is achieved by the aforementioned use, according to which the bearing cover is tensioned together with the bearing with at least partly uncalibrated clamping surfaces.

The term “sinter-roughened” is defined in terms of the invention as the condition of the surface condition on the bearing cover after sintering without further mechanical rocessing and treatment. A sinter-roughened surface is thus the surface that the bearing cover has immediately after the sintering and cooling of the bearing cover at room temperature.

By means of this design of the clamping surfaces the frictional connection between the bearing block and the bearing cover is improved. In this way it is possible to reduce the risk that the bearing cover might slide when tensioning together with the bearing block, particularly when the bearing cover is mounted for the first time on the bearing block. Furthermore, by means of the improved frictional connection the connection of the bearing block/bearing cover can also absorb higher mechanical loads during the operation of the split bearing arrangement. An additional effect is that the production costs of the bearing cover can be reduced, particularly if the latter is not fully calibrated after sintering, as in this way it is possible to reduce the number of production steps.

According to one embodiment variant of the bearing cover it is possible that the surface of the clamping surfaces comprises pores. In this way it is also possible to improve the tensionability and mountability of the bearing cover, as in this way during the tensioning process there can be a simpler displacement of material into the pores.

To improve the ability of the bearing cover to be (re)positioned on the bearing block and to further improve the mechanical loadability of the split bearing arrangement in operation, it is possible to form at least one projection on the clamping surfaces projecting out from the latter respectively, which can be pushed into the counter clamping surface of the bearing block. By pushing this into the counter clamping surface a position mark is made in the counter clamping surfaces for repositioning.

Preferably, the at least one projection has a cross-section which varies over its length on the clamping surface, whereby the bearing cover can be positioned on the bearing block in a particular position depending on the direction.

According to a further embodiment variant it is also possible for the projection to have two end parts and as viewed in plan view a central part which is tapered compared to the two end parts. In particular, this geometry has proved to be advantageous for distributing tensions introduced into the bearing block when clamping together with the bearing cover.

According to one embodiment variant of the method to increase the surface roughness of the clamping surfaces of the bearing cover it is possible that for the pressing the metallic powder a stamp and/or a die is used with an averaged roughness depth R_{z}, which is selected from a range of 4 μm to 50 μm.

For a better understanding of the invention the latter is explained in more detail with reference to the following Figures.

In a simplified, schematic view:

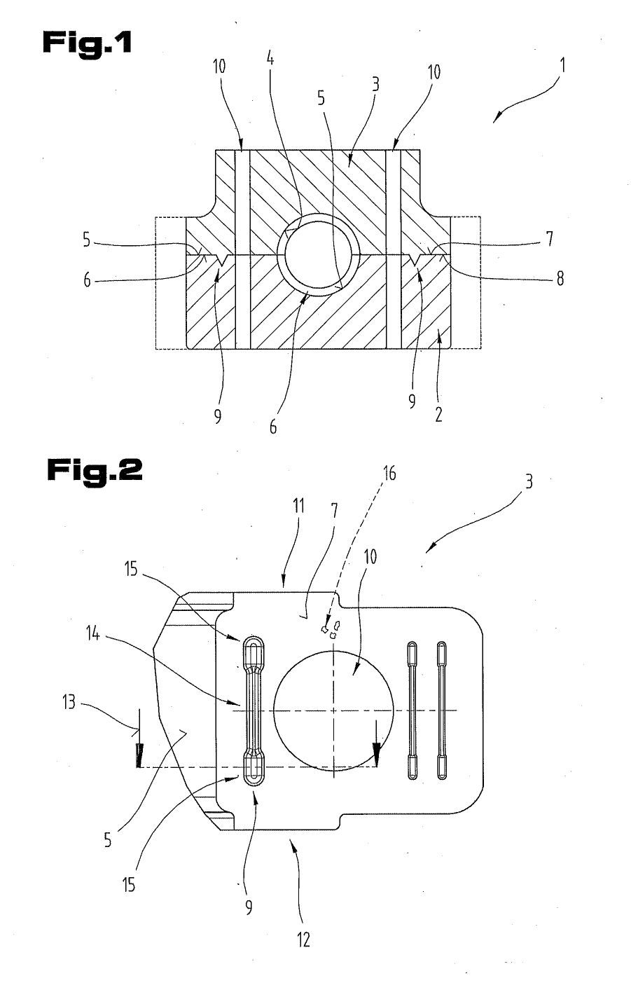

FIG. 1 is a cross-section of a split bearing arrangement;

FIG. 2 is a plan view of a clamping surface of the bearing cover.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

In this description details regarding standards relate to the current version of said standards which are valid on the date of the present application, unless otherwise specified.

FIG. 1 shows a split bearing arrangement 1, as used for example in a machine housing of a piston machine. Said bearing arrangement 1 comprises a bearing block 2 and a bearing cover 3, which together provide a first and a second bearing mounting surface 4, 5 for mounting a sliding bearing 6, for example for supporting a crankshaft. The sliding bearing 6 can be formed for example by two half-shells or a socket. It is however also possible to directly coat the bearing mounting surfaces 4, 5 with a sliding bearing material.

The bearing mounting surfaces 4, 5 are formed by radially inner surfaces of the bearing block 2 or the bearing cover 3, which surround an opening for mounting the components to be supported.

The bearing cover 3 comprises at both distal end parts respectively a clamping surface 7 and the bearing block 2 comprises at both end parts counter clamping surfaces 8 lying opposite the clamping surfaces 7, which bear on one another in the assembled state of the bearing arrangement 1.

According to one embodiment variant of the bearing cover 3 at least one projection 9 per clamping surface 7 can be arranged projecting beyond the clamping surfaces 7, which in the assembled state of the bearing arrangement 1 are pushed into the counter clamping surface 8 of the bearing block 2 by tensioning together the bearing block 2 and bearing cover 3.

For tensioning the bearing block 2 to the bearing cover 3 a continuous threaded bolt mount 10, for example a bore, is arranged at the distal end parts respectively. In said threaded bolt mount 10 a bolt is mounted, which is not shown in more detail, and pretensioning is achieved by means of corresponding nuts. Alternatively to this, in the bearing block 2 or in the bearing cover 3 said threaded bolt mount 10 can be designed not be continuous but as a blind bore with an internal thread.

The at least one projection 9 can have a cross-section which varies over its length on the clamping surface 7. For technical production reasons it is preferred if the projection has a varying width and/or height over its length or if according to one embodiment variant the projection has a cross-section which tapers in the direction of a width of the clamping surface.

According to another preferred embodiment variant of the bearing cover 3 the projections 9 can be designed to be approximately bone-shaped or strip-like, with a longitudinal extension from a front side 11 to a rear side 12 of the bearing cover 3 (i.e. in axial direction 13) as shown in FIG. 2, which shows a plan view of one of the clamping surfaces 7 of the bearing cover 3. The projections 9 preferably have a central part 14, which is designed to be thinner than the two end parts 15.

As also shown in FIG. 2, also different projections 9 can be arranged on a clamping surface 7, for example one wide projection 9 and one or two or more projections 9 which are thinner by comparison, wherein also in this case all projections 9 are preferably designed to be “bone-like”, as explained above. In this embodiment variant the said wider projection 9 is arranged preferably closer to the bearing mounting surface 5 of the bearing cover 3 than the other projections 9. The wider projection 9 is also preferably on one side of the threaded bolt mount 10 and the one or more thinner projections 9 are preferably arranged on the other side of the threaded bolt mount 10. In other words, the threaded bolt mount 10 is preferably arranged between the wider projection and one or more thinner projections 9.

However, differently designed projections 9 can also be provided, for example with a cutting edge, wherein also combinations of forms are possible, in that for example the bone-like projections 9 can be designed to be blade-like. However, the described bone-like projections 9 are preferred.

The projections 9 are also preferably formed in one piece with the rest of the bearing cover 3.

It is also possible, as indicated by dashed lines in FIG. 1, that the distal end parts of the bearing cover 3 are formed in the direction of the bearing block 2 laterally overlapping the latter, or that conversely the bearing block 2 is arranged laterally overlapping the bearing cover 3.

Likewise, the projections 9 can also be formed on the counter clamping surfaces 8 of the bearing block 2, wherein it is preferred if the latter are arranged exclusively on the clamping surfaces 7 of the bearing cover 3.

At least the projections 9 are made from a material which is harder than the material of the bearing block 2 in the area of the counter clamping surface 8, so that said projections 9 can be pushed into the counter clamping surface 8 by pushing together and tensioning the bearing block 2 and bearing cover 3. Preferably however, the whole bearing cover 3 is made from this harder material. For example the bearing cover 3 can be made from an iron material and the bearing block 2 can be made from a light metal. In particular, the bearing cover 3 is made from a sintered iron material.

The bearing cover 3 is generally made from a sintered material by means of a powder-metallurgical method.

Powder-metallurgical methods and/or sintering methods are already known from the prior art, and thus only the main features of the method are described in the following.

The preferred metal powders generally consist of hybrid-alloyed, prealloyed or alloyed iron powders which function as base powders and form alloys by admixing additional alloy powders (in commercially available states or purities) such as Cu, Ni, Mn, Cr, Si, Mo, V etc. as well as graphite and pressing additives during the sintering by diffusion. The alloy systems can thus be determined so that a cooling process which may follow the sintering at cooling speeds of about 2 to 16 K/s results in the hardening of the bearing cover 3. Hybrid alloys have the advantage that said hardening alloy elements are already distributed accordingly in the microstructure.

The powder mixtures are produced with a total of up to 15 wt. % metallic non-iron alloy elements, up to 5 wt. % graphite, up to 3 wt. % pressing additives and up to 1 wt. % organic binding agent. Other alloy powders can also be used however.

Resins, silanes, oils, polymers or adhesives can be used as binding agents. Pressing additives include waxes, stearates, silanes, amides and polymers.

Said powder(mixtures) are compacted by coaxial pressing methods and shaped. Depending on the bulk density and theoretical density of the powder mixtures pressing forces of 600 to 1200 MPa can be used for this. The compacted parts obtained in this way (also known as green compacts) are the starting point for subsequent processing steps.

Instead of the coaxial pressing methods also other pressing methods can be used, as are usual in sintering technology, e.g. also isostatic pressing methods etc.

The green compacts are then sintered in one step or multiple steps. In this way reducing atmospheres can be provided by using nitrogen-hydrogen mixtures with up to 30 vol. % hydrogen. Optionally also carburizing gases can be used (endogas, methane, propane and the like) or added to the nitrogen-hydrogen mixture. The proportion can be selected from a range with a lower limit of 0.01 vol. % and an upper limit of 2.55 vol. % relative to the whole mixture.

The temperatures during the sintering can be between 750° C. and 1350° C. The green compacts can be kept at this temperature for between 10 minutes and 65 minutes.

After the sintering and cooling the sintered bearing cover 3 can still be post-processed mechanically in some areas, for example by machining. Areas of the bearing cover 3 can also be calibrated.

However, it is also the case that at least a portion of the clamping surfaces 7 is not calibrated, said portion thus having a sinter-roughened surface, i.e. the surface that is left directly after sintering and cooling the bearing cover 3. The clamping surfaces thus remain untreated at least in some areas after sintering.

In the preferred embodiment variant the whole bearing cover 3 is not calibrated. The bearing cover 3 is thus not pressed or compacted again after sintering. The clamping surfaces (7) thus have the averaged roughness depth R_{z} of the stamp used.

The clamping surfaces (7) thus have an averaged roughness depth R_{z} according to DIN EN ISO 4287 of between 4 μm and 10 μm.

According to a further embodiment variant of the bearing cover 3 it is possible for the surfaces of the clamping surfaces (7) to have pores, as indicated by dashed lines in FIG. 2.

According to one embodiment variant of the method in order to increase the surface roughness at least a portion of the clamping surfaces 7, in particular the whole area of the clamping surfaces 7, it is possible that for pressing the metallic powder a stamp is used with an averaged roughness depth R_{z} according to DIN EN ISO 4287 at least in the area of part of the form of the clamping surfaces 7, which is selected from a range of 10 μm and 50 μm. The clamping surfaces 7 of the bearing cover 3 can thus at least in some areas, in particular fully, copy this surface roughness at least approximately, so that the clamping surfaces 7 at least in some areas, in particular fully, can have surface roughness according to DIN EN ISO 4287 of 10 μm and 50 μm.

The clamping surfaces 7 can thus have an averaged roughness depth R_{z} according to DIN EN ISO 4287 of between 4 μm and 50 μm.

The bearing cover 7 is inserted with said clamping surfaces 7, which are uncalibrated at least in some areas, in particular fully, into the split bearing arrangement 1 and clamped together with the bearing block 2.

Lastly, as a point of formality, it should be noted that for a better understanding of the structure of the bearing cover 3 and the split bearing arrangement 2 the latter is not necessarily shown to scale.

### LIST OF REFERENCE NUMERALS

1 bearing arrangement

2 bearing block

3 bearing cover

4 bearing mounting surface

5 bearing mounting surface

6 sliding bearing

7 clamping surface

8 counter clamping surface

9 projection

10 threaded bolt mount

11 front side

12 rear side

13 axial direction

14 central part

15 end part

16 pore

1. A bearing cover (3) for a split bearing arrangement (1) which in addition to the bearing cover (3) comprises a bearing block (2), wherein the bearing cover (3) comprises clamping surfaces (7), which in the assembled state of the bearing arrangement (1) bear on counter clamping surfaces (8) of the bearing block (2), wherein at least the clamping surfaces (7) have a sinter-roughened surface at least in some areas.

2. The bearing cover (3) as claimed in claim 1, wherein the surface of the clamping surface (7) comprises pores.

3. The bearing cover (3) as claimed in claim 1, wherein at least one projection (9) is formed on the clamping surfaces (7) and projects over the latter, which projection can be pushed into counter clamping surface (8) of the bearing block (2).

4. The bearing cover (3) as claimed in claim 3, wherein the at least one projection (9) has a cross-section which varies over its length on the clamping surface (7).

5. The bearing cover (3) as claimed in claim 4, wherein the projection (9) has two end parts (15) and as viewed in plan view has a central part (14) which is tapered compared to the two end parts (15).

6. A bearing arrangement (1) comprising a bearing cover (3) and a bearing block (2) bearing on the latter, wherein the bearing cover (3) is formed as claimed in claim 1.

7. A method for the powder metallurgical production of a bearing cover (3) for a split bearing arrangement (1), which in addition to the bearing cover (3) comprises a bearing block (2), wherein the bearing cover (3) comprises clamping surfaces (7) which in the assembled state of the bearing arrangement (1) bear on counter clamping surfaces (8) of the bearing block (2), comprising the steps of pressing metal powder into a green compact in the form of the bearing cover (3) and sintering the green compact at sintering temperature into a sintered bearing cover (3), wherein at least the clamping surfaces (7) remain at least partly untreated after sintering.

8. The method as claimed in claim 7, wherein for pressing the metal powder a die is used with an averaged roughness depth Rz according to DIN EN ISO 4287, which is selected from a range of 4 μm to 50 μm.

9. A use of a bearing cover (3) produced by means of powder metallurgy in a split bearing arrangement (1), which in addition to the bearing cover (3) comprises a bearing block (2), the bearing cover (3) comprising clamping surfaces (7), which in the assembled state of the bearing arrangement (1) bear on counter clamping surfaces (8) of the bearing block (2), wherein the bearing cover (3) with at least partly uncalibrated clamping surfaces (7) is clamped together with the bearing block (2).
